(19) United States
(12) Patent Application Publication
(10) Pub. No.: US 2025/0011603 A1
(43) Pub. Date: Jan. 9, 2025

(54) Two-part, room temperature curable heat and fire retardant composition

(71) Applicant: Henkel AG & Co. KGaA, Duesseldorf (DE)

(72) Inventors: Uwe Franken, Dormagen (DE); Umesh Harkal, Bonez (IN); Abhijit Hirekerur, Pune (IN); Sandeep Kothawade, Pune (IN)

(21) Appl. No.: 18/897,509

(22) Filed: Sep. 26, 2024

Related U.S. Application Data
(63) Continuation of application No. PCT/EP2023/057301, filed on Mar. 22, 2023.

(30) Foreign Application Priority Data
Apr. 8, 2022 (IN) 202241021136

(51) Int. Cl. C09D 5/18; C08K 3/016; C08K 3/22; C08K 3/36; C08K 5/523; C09D 163/00; H01M 50/222; H01M 50/227; H01M 50/229; H01M 50/24; H01M 50/249

(52) U.S. Cl. CPC C09D 5/18; C09D 163/00; C08K 3/016; C08K 3/22; C08K 2003/2241; C08K 2003/2265; C08K 3/36; C08K 5/523; H01M 50/222; H01M 50/227; H01M 50/229; H01M 50/24; H01M 50/249; H01M 2220/20

(57) ABSTRACT

The present invention relates to a two-part, room temperature curable heat and fire retardant composition comprising a first part comprising 1) an epoxy resin; and 2) a flame retardant compound; and a second part comprising 1) a first amine comprising N,N′-bis(3-aminopropyl)ethylenediamine and 3,3′-oxybis(ethylene-oxy) bis(propylamine); 2) a second amine comprising m-phenylenebis(methylamine) and formaldehyde, polymer with 1,3-benzenedimethanamine and phenol; and 3) a flame retardant compound. The composition according to the present invention can be used as a heat and fire retardant coating composition or a structural adhesive or a potting compound, especially as a coating composition for car battery boxes.

### FIELD OF THE INVENTION

The present invention is directed to a two-part, room temperature curable heat and fire retardant composition, which can be used as a coating composition or a structural adhesive or a potting compound.

### BACKGROUND OF THE INVENTION

Number of electric vehicles have increased in the recent years and a battery is a main power source in the electric vehicles. Since the battery is the main power source for the electric vehicles, battery capacity, energy density, and fire safety are major concerns for all electric vehicle manufacturers. However, the battery safety is one of the most important challenges. In accidents involving collisions, an electric vehicle can catch a fire, and therefore, the battery should be capable to withstand an external heat and fire, thus extending the time for passengers to evacuate the electric vehicle.

One way to enable the battery of the electric vehicle to withstand elevated external heat and fire is a fireproof coating. The fireproof coating is suitable for both traditional battery casings made of iron, steel, and aluminium alloy as well as light-weight plastic casings made of PPS, SMC, flame-retardant PP, nylon and glass fibre. The fireproof coating is a lightweight and effective way to protect the battery from fire compared to alternative fire protection concepts.

Generally, the fire protection coating is a material that, in the event of a fire, the material comes into a contact with heat and fire, it expands from a coating thickness of few millimetres to a thick foam layer of several centimetres (up to expansion rate of 40 times the thickness of the coating layer). This type of coating is also called to an intumescent coating. The expanded coating layer effectively insulates the battery compartment from the elevated temperature and fire, and therefore, prevents burns caused by a drastic rise in temperature inside the battery, stabilizes the structure of the battery box, and ultimately provides more time to the passengers to evacuate the vehicle.

One way to provide a fire protection coating is to use of mica sheets as a fire protection coating. However, the use of mica sheets is a manual and labour-intensive process. Therefore, this coating type is not suitable for large production volumes, which require high speed and accuracy.

Another way to provide the fire protection coating is to apply a fire retardant composition on a surface of a battery box. There are various 1 k and 2 k fire retardant compositions available for different surfaces, however, most of such compositions do not meet required heat and fire-retardant properties or meet the high process speed and accuracy requirements for battery box coating applications.

Therefore, there is still a need for a heat and fire retardant coating composition, having a faster cure speed, and enabling an automated and accurate high-speed process for applying a heat and fire retardant coating on a battery box, while maintain excellent heat and fire retardant properties.

### SHORT DESCRIPTION OF THE FIGURES

FIG. 1 illustrates a test method used to determine coatings' ability to resist heat and fire over a defined period of time.

FIG. 2 illustrates comparative test results on heat and fire retardance between the composition according to the present invention and commercially available compositions.

FIG. 3 illustrates the viscosity over time when measured at 30° C.

FIG. 4 illustrates the viscosity over time when measured at 35° C.

FIG. 5 illustrates the viscosity over time when measured at 40° C.

FIG. 6 illustrates the tack free time changes depending on the quantity of the first amine.

FIG. 7 illustrates the tack free time changes depending on the quantity of the second amine.

### SUMMARY OF THE INVENTION

The present invention relates to a two-part, room temperature curable heat and fire retardant composition comprising a first part comprising 1) an epoxy resin; and 2) a flame retardant compound; and a second part comprising 1) a first amine comprising N,N′-bis(3-aminopropyl)ethylenediamine and 3,3′-oxybis(ethylene-oxy) bis(propylamine); 2) a second amine comprising m-phenylenebis(methylamine) and formaldehyde, polymer with 1,3-benzenedimethanamine and phenol; and 3) a flame retardant compound.

The present invention also relates to use of a two-part, room temperature curable heat and fire retardant composition according to the present invention as a coating composition or a structural adhesive or a potting compound.

The present invention encompasses a process to apply a two-part, room temperature curable heat and fire retardant composition according to the present invention on a substrate comprising a step of applying the composition via a contactless coating, preferably via a flat stream coating or a spray coating, more preferably via flat stream coating.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements, or method steps.

As used herein, the term “consisting of” excludes any element, ingredient, member, or method step not specified.

The words “preferred”, “preferably”, “desirably” and “particularly” are used frequently herein to refer to embodiments of the disclosure that may afford particular benefits, under certain circumstances. However, the recitation of one or more preferable, preferred, desirable or particular embodiments does not imply that other embodiments are not useful and is not intended to exclude those other embodiments from the scope of the disclosure.

As used throughout this application, the word “may” is used in a permissive sense—that is meaning to have the potential to—rather than in the mandatory sense.

The recitation of numerical end points includes all numbers and fractions subsumed within the respective ranges, as well as the recited end points.

All percentages, parts, proportions and then like mentioned herein are based on weight unless otherwise indicated.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

As used herein, the term “one component (1K) composition” refers to a composition where, during storage of the composition, the composition components are all admixed together but the properties of the composition, including viscosity, remain consistent enough over the time of storage to permit successful utility of the composition at a later time.

“Two-component (2K) compositions” are understood to be compositions in which a first component/part and a second component/part must be stored in separate vessels because of their (high) reactivity. The two components/parts are mixed only shortly before application and then react, typically without additional activation, with bond formation and thereby formation of a polymeric network. Herein higher temperatures may be applied in order to accelerate the cross-linking reaction.

All references cited in the present specification are hereby incorporated by reference in their entirety.

Unless otherwise defined, all terms used in disclosing the invention, including technical and scientific terms, have the meaning as commonly understood by one of the ordinary skilled in the art to which this invention belongs to. By means of further guidance, term definitions are included to better appreciate the teaching of the present invention.

The present invention relates to a two-part, room temperature curable heat and fire retardant composition comprising a first part comprising 1) an epoxy resin; and 2) a flame retardant compound; and a second part comprising 1) a first amine comprising N,N′-bis(3-aminopropyl)ethylenediamine and 3,3′-oxybis(ethylene-oxy) bis(propylamine); 2) a second amine comprising m-phenylenebis(methylamine) and formaldehyde, polymer with 1,3-benzenedimethanamine and phenol; and 3) a flame retardant compound.

The present invention also relates to a two-part, room temperature curable heat and fire retardant composition comprising a first part comprising 1) an epoxy resin; and 2) a flame retardant compound; and a second part comprising 1) a first amine consisting of N,N′-bis(3-aminopropyl)ethylenediamine and 3,3′-oxybis(ethylene-oxy) bis(propylamine); 2) a second amine consisting of m-phenylenebis(methylamine) and formaldehyde, polymer with 1,3-benzenedimethanamine and phenol; and 3) a flame retardant compound.

The Applicant has found out that the combination of the first amine and the second amine in the composition according to the present invention increases the control over the cross linking, as well the speed of the cross linking. Further, the composition is curable at the room temperature. These composition features provide a high degree of automation for mass production for example coating of the battery boxes of the electric vehicles. In addition, use of the composition according to the present invention provides reduced waste due to a highly accurate, automated, and high-speed application process. By highly accurate application process is meant that there is hardly any over spray during the process. In addition, the composition according to the present invention can be applied as a thin and lightweight layer of a protective coating while providing heat and flame retardant properties and insulation properties which reduces propagation of temperature to the outside of the battery box.

The two-part, room temperature curable heat and fire retardant composition according to the present invention comprises an epoxy resin. The epoxy resin is present in the first part of the composition.

Preferably, the epoxy resin is selected from the group consisting of epoxy resin based on bisphenol A and epichlorohydrin, bisphenol-A diglycidyl ether epoxy resin; bisphenol-F diglycidyl ether epoxy resin; cresol novolac epoxy resin, a C4-28 alkylene diglycidyl ether, a C2-28 alkylene- and/or alkenylene-diglycidyl ester; a C2-28 alkylene-, mono- and poly-phenol glycidyl ether; a polyglycidyl ether of trimethylol propane, pyrocatechol, resorcinol, hydroquinone, 4,4′,4″-trihydroxyphenyl methane, 4,4′-dihydroxydiphenyl methane, 4,4′-dihydroxy-3,3′-dimethyldiphenyl methane, 4,4′-dihydroxydiphenyl dimethyl methane, 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, or tris(4-hydroxyphyenyl)methane; a methylenebis(naphthalene)-diol, -triol, or -tetrol, 2,7,2′,7′-tetraglycidyloxynaphthalene methane and/or 1,1,2,2-tetrakis(4-glycidyloxyphenyl)ethane, cresol novolac epoxy resin sorbitol glycidyl ether, and mixtures thereof, more preferably the epoxy resin is based on bisphenol A and epichlorohydrin.

Above listed epoxy resins are preferred, and especially, the epoxy resin based on bisphenol A and epichlorohydrin is preferred, because they are able to resist flames when exposed to under the flame test.

Suitable commercially available epoxy resin for use in the present invention include but is not limited to D.E.R 331 from Olin.

A two-part, room temperature curable heat and fire retardant composition according to the present invention may have the epoxy resin present from 30 to 60% by weight of the total weight of the first part of the composition, preferably from 35 to 50% and more preferably from 38 to 42%.

The above ranges are preferred because they may provide optimal heat and flame retardant behaviour and rheological behaviour for the composition.

A two-part, room temperature curable heat and fire retardant composition according to the present invention comprises a flame retardant compound. The flame retardant compound may be present in the first part of the composition or in the second part of the composition or in both first and second parts.

The flame retardant compound in the first part and in the second part can be same or different and is independently selected from the group consisting of, aluminium trihydroxide, mica, calcium carbonate, arsenic oxide, expanded graphite, calcium sulfate, cyanuric acid derivatives, cresyl diphenyl phosphate, triphenyl phosphate, tricresyl phosphate, tris-(isopropylated phenyl)-phosphate, trixylyl phosphate, tritoluyl phosphate, 2-ethylhexyl diphenyl phosphate, decyl diphenyl phosphate, tris-(2-chloroethyl)-phosphate, tris-(2-chloropropyl)-phosphate, tris-(2,3-dibromopropyl)-phosphate, tetrakis-(2-chloro)-ethylene diphosphate, dimethyl methyl phosphonate, diethyl ethyl phosphonate, chloroparaffins, hexabromobenzene, brominated diphenylethers, dibromoneopentyl glycol, mono pentaerythritol, dipentaerythritol, coated red phosphorus and mixtures thereof, preferably selected from cresyl diphenyl phosphate, calcium carbonate, ammonium polyphosphate and mixtures thereof.

The above preferred flame retardant compounds are preferred because they enable that the composition according to the present invention may be applied as a thin and lightweight layer of a protective coating, which reduce propagation of temperature and provides flame retardant and heat insulation properties.

Suitable commercially available flame retardant compounds for use in the present invention include but are not limited to Omya BLH from Omya and Disflamoll DPK from Lanxess.

A two-part, room temperature curable heat and fire retardant composition according to the present invention may have the flame retardant compound present in the first part from 35 to 65% by weight of the total weight of the first part of the composition, preferably from 45 to 60% and more preferably from 51 to 57%.

A two-part, room temperature curable heat and fire retardant composition according to the present invention may have the flame retardant compound present in the second part from 20 to 65% by weight of the total weight of the second part of the composition, preferably from 50 to 60% and more preferably from 51 to 57%.

The above ranges provide good viscosity for the composition, as well as good mixing properties. Especially, if the quantity of the flame retardant compound is too low, the thermal propagation properties may be adversely affected, and further, the composition may become free flowing, and therefore, difficult to mix. Whereas too high quantities may have a negative impact to an application process.

The two-part, room temperature curable heat and fire retardant composition according to the present invention comprises a combination of a first amine and a second amine. The first amine and the second amine are present in the second part of the composition.

The first amine comprises a mixture of N,N′-bis(3-aminopropyl)ethylenediamine and 3,3′-oxybis(ethylene-oxy) bis(propylamine) and the second amine comprises a mixture of m-phenylenebis (methylamine) and formaldehyde, polymer with 1,3-benzenedimethanamine and phenol.

In one embodiment, the first amine is consisting of a mixture of N,N′-bis(3-aminopropyl)ethylenediamine and 3,3′-oxybis(ethylene-oxy) bis(propylamine) and the second amine is consisting of a mixture of m-phenylenebis(methylamine) and formaldehyde, polymer with 1,3-benzenedimethanamine and phenol.

The above-mentioned mixture of the first and the second amines is chosen and used because it resisted well flames when exposed under the flame test. Further, the Applicant has found out that the use of a combination of above mentioned first and second amines provides control of the speed of cross linking and increase the speed of the cross linking.

The two-part, room temperature curable heat and fire retardant composition according to the present invention may have the first amine and the second amine present in a ratio of from 60:40 to 99:1.

The ratio of from 60:40 to 99:1 is preferred because the reaction rate is depending on the proportional quantity of the second amine. If the ratio of the second amine is too high, it may lead to too fast reaction, which may adversely affect the application process.

Suitable commercially available first amine for use in the present invention include but is not limited to Ancamine 2432 from Evonik. And suitable commercially available second amine for use in the present invention include but is not limited to Ancamine 2914UF from Evonik.

The two-part, room temperature curable heat and fire retardant composition according to the present invention may have the first amine and the second amine present in the second part of the composition from 30 to 50% by weight of the total weight of the second part of the composition, preferably from 38 to 48% and more preferably from 43 to 47%.

The above-mentioned range based on the quantity of the epoxy resin in the first part and is preferred because it may lead to a complete reaction, without unreacted epoxy resin in the composition.

The two-part, room temperature curable heat and fire retardant composition according to the present invention may further comprise a rheology modifier. The rheology modifier may be present in the first part of the composition and/or the second part of the composition.

The rheology modifier may be same or different in the first part and the second part of the composition, and the rheology modifier is independently and preferably selected from the group consisting of fumed silica, fused silica, amorphous silica, hydrous silica, mineral nano silicate clay, and mixtures thereof, more preferably the rheology modifier is fumed silica.

Fumed silica is specifically preferred rheology modifier because its presence may enhance the viscosity of the composition during the application process (spraying). Examples of such fumed silicas include polydimethylsiloxane-treated silicas and hexamethyldisilazane-treated silicas.

Suitable commercially available rheology modifiers for use in the present invention include but are not limited to CAB-O-SIL ND-TS, TS610, TS710 and TS720 from Cabot Corporation and AEROSIL R805, R8200, 300 and 200 from Degussa Corporation.

The two-part, room temperature curable heat and fire retardant composition according to the present invention may have the rheology modifier present in the first part of the composition from 0.1 to 5% by weight of the total weight of the first part, preferably from 0.2 to 3% and more preferably from 0.3 to 1.5% and/or the rheology modifier may be present in the second part of the composition from 0.1 to 5% by weight of the total weight of the second part, preferably from 0.2 to 3% and more preferably from 0.3 to 1.5%.

The above ranges have been found to be ideal to provide a good viscosity profile for the first and the second parts without viscosity built up.

The two-part, room temperature curable heat and fire retardant composition according to the present invention may further comprises a pigment. The pigment may be present in the first part of the composition and/or the second part of the composition.

The pigment may be same or different in the first part and the second part of the composition and is independently selected from the group consisting of titanium dioxide, carbon black, graphite, iron oxide and mixtures thereof, preferably the pigment is selected from the group consisting of titanium dioxide, carbon black, iron oxide, and mixtures thereof.

The two-part, room temperature curable heat and fire retardant composition according to the present invention may have the pigment present in the first part of the composition from 0.1 to 5% by weight of the total weight of the first part, more preferably from 0.2 to 3% and even more preferably from 0.3 to 1.5% and/or the pigment may be present in the second part of the composition from 0.1 to 5% by weight of the total weight of the second part, preferably from 0.2 to 3% and more preferably from 0.3 to 1.5%.

The two-part, room temperature curable heat and fire retardant composition according to the present invention is prepared by first combining all the ingredients of the first part in one container and mixing them and secondly combining all the ingredients of the second part in another container and mixing them, and subsequently combining and mixing the first and second parts prior to the use.

A two-part, room temperature curable heat and fire retardant composition according to the present invention wherein the first part and the second part are mixed in a ratio of from 1.9:1.1 to 2.1:0.9, preferably in ratio of 2:1.

The above-mentioned range is based on the quantity of the epoxy resin in the first part and the total amine quantity in the second part, and is preferred, because it may lead to a complete reaction, without unreacted epoxy resin be present in the final composition.

The thermal propagation test, which is described in detail in the example section below, is important method to evaluate how long the coating material is able to maintain the temperature below target temperature over set period of time when exposed to heat and/or fire. The two-part, room temperature curable heat and fire retardant composition according to the present invention is able to maintain the temperature well below 300° C. for at least ten minutes in the thermal propagation test.

The two-part, room temperature curable heat and fire retardant composition according to the present invention can be used as a coating composition or a structural adhesive or a potting compound. The Applicant has found out that the composition according to the present invention is particularly suitable for use as a coating composition for electric vehicle battery boxes.

The present invention relates to a process to apply a two-part, room temperature curable heat and fire retardant composition according to the present invention on a substrate. The process to apply the composition according to the present invention on a substrate comprises a step of applying the composition via a contactless coating, preferably via a flat stream coating or a spray coating, more preferably via flat stream coating.

The composition according to the present invention provides a high degree of automation for a mass production, which is needed for coating of the battery boxes. In addition, use of the composition according to the present invention provides reduced waste due to a highly accurate (hardly any overspray), automated and high-speed application process.

### EXAMPLES

The compositions in the below examples were prepared as follows:

All the ingredients of the first part were combined in one container (Flacktec plastic container) and mixed by Flacktec speed mixer at the same time all the ingredients of the second part were combined in another container (Flacktec plastic container) and mixed by Flacktec speed mixer. Subsequently the first and second parts were combined together to yet another container (Flacktec plastic container) and mixed by Flacktec speed mixer prior the use.

### Example 1

### First Part

| Name | Chemical compound | wt % |
|---|---|---|
| D.E.R. 331 from Olin | Epoxy resin based on Bisphenol-A | 42.9 |
| | and epichlorohydrin | |
| Exolit AP 422 from | Ammonium polyphosphate | 20.3 |
| Clariant | | |
| Apyral 16 | Aluminum trihydroxide | 27.8 |
| Disflamoll DPK from | Cresyl diphenyl phosphate | 7.5 |
| Lanxess | | |
| Cab O Sil M 720 from | Fumed silica | 0.5 |
| Cabot | | |
| TiO2 (Rutil) from Kronos | Titanium dioxide | 1 |

### Second Part

| Name | Chemical compound | wt % |
|---|---|---|
| Ancamine 2432 from | Modified aliphatic amine | 27.5 |
| Evonik | | |
| Ancamine 2914UF from | Modified aliphatic amine | 16.5 |
| Evonik | | |
| Exolit AP 422 from | Ammonium polyphosphate | 27.9 |
| Clariant | | |
| Omya BLH from Omya | Calcium carbonate | 26.1 |
| Cab O Sil M 5 from | Fumed silica | 1 |
| Cabot | | |
| Bayferrox 306 from | Iron oxide | 1 |
| Lanxess | | |

The first part and second part were combined in the ratio of 2:1.

### Comparative Example 1

| Name | Chemical compound | wt % |
|---|---|---|
| Kane AceMX 154 from Kaneka | Core Shell Rubber (CSR) in | 64 |
| Corp. | unmodified bisphenol A, | |
| | epichlorohydrin resin | |
| Erisis GE 20 from Huntsman | Neopentyl glycol diglycidyl | 16.95 |
| | ether | |
| Dynasylan Glymo from Evonik | Glycidoxy propyl trimethoxy | 2.10 |
| | silane | |
| Exolit AP 422 from Clariant | Ammonium polyphosphate | 16.95 |

### Second Part

| Name | Chemical compound | wt % |
|---|---|---|
| Ancamine 2432 from Evonik | Modified aliphatic amine | 50.85 |
| Ancamine 2914 from Evonik | Modified aliphatic amine | 25.42 |
| Jeffamine T 5000 from | Glycerol propylene oxide adduct | 8.47 |
| Huntsman | triamine | |
| Exolit AP 422 from Clariant | Ammonium polyphosphate | 15.25 |

First part and second part were mixed in ratio of 1:1.

The composition was coated on a substrate and exposed to flames—the flames burn off the coating formed by composition according to comparative example 1. In other words, the composition does not withstand flame.

### Comparative Example 2

### First Part

| Name | Chemical compound | wt % |
|---|---|---|
| Epon 828 from Hexion | Epoxy resin based on Bisphenol-A | 33.94 |
| | and epichlorohydrin | |
| Exolit AP 422 from Clariant | Ammonium polyphosphate | 66.06 |

### Second Part

| Name | Chemical compound | wt % |
|---|---|---|
| Ancamine 2432 from Evonik | Modified aliphatic amine | 27.24 |
| Ancamine 2914 from Evonik | Modified aliphatic amine | 17.03 |
| Jeffamine T 5000 from | Glycerol propylene oxide adduct | 55.73 |
| Huntsman | triamine | |

First part and second part were mixed in ratio of 3:1.

The composition was coated on a substrate and exposed to flames—the flames burn off the coating formed by composition according to comparative example 2. In other words, the composition does not withstand flame.

### Comparative Example 3

### First Part

| Name | Chemical compound | wt % |
|---|---|---|
| Epon 828 from Hexion | Epoxy resin based on Bisphenol-A | 25.67 |
| | and epichlorohydrin | |
| DEN 438 Dow chemicals | Epoxy Novolac | 8.25 |
| Exolit AP 422 from Clariant | Ammonium polyphosphate | 66.06 |

### Second Part

| Name | Chemical compound | wt % |
|---|---|---|
| Ancamine 2432 from Evonik | Modified aliphatic amine | 49.91 |
| Ancamine 2914 from Evonik | Modified aliphatic amine | 31.20 |
| Exolit AP 422 from Clariant | Ammonium polyphosphate | 55.7 |

First part and second part were mixed in ratio of 2:1.

The composition was coated on a substrate and exposed to flames—the flames burn off the coating formed by composition according to comparative example 3. In other words, the composition does not withstand flame.

### Example 4

Thermal propagation prevention was tested by comparing three different coating compositions on a steel plate. Composition according to example 1 were tested and compared to commercially available coating LOCTITE FCP 5060 from Henkel AG & Co. KGaA and e-coating from Euro Quality Coatings. Fire test target is to have a temperature (T2) which is less than 300° C. after the coating is exposed to a temperature of 1000° C. for 10 min.

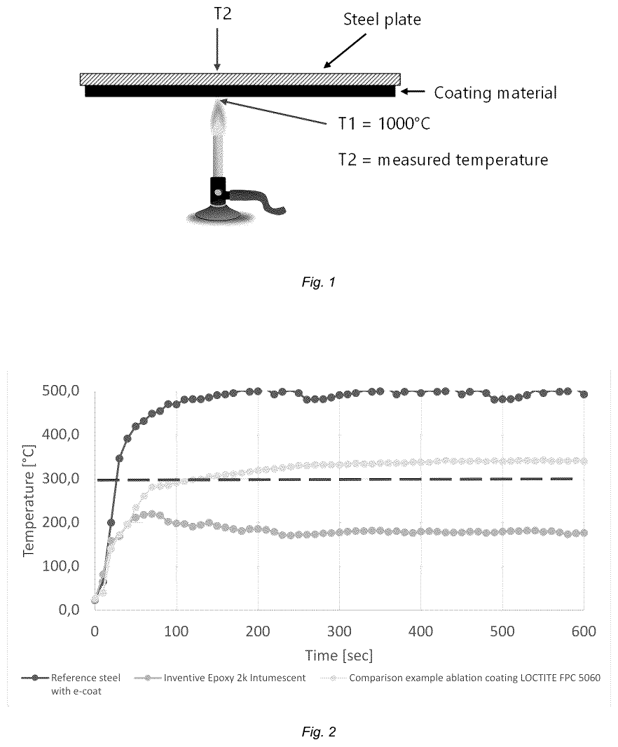

Thermal propagation test method—the basic principle is illustrated in FIG. 1. Coating thickness is 700 μm and T2 is the measured temperature which is then illustrated in the diagram vs. time. The graph illustrates the temperature development over the time of a steel sheet protected with the above-mentioned coating compositions. The test results are illustrated in FIG. 2. The composition according to the present invention performs the best in this test and is able to maintain the temperature (T2) well below 300° C. for at least 10 minutes.

### Example 5

The viscosity increase over time of the mixed composition (first part and second part) was measured for the two different compositions, composition according to the present invention comprising a combination of 27.5% Ancamine 2432 and 16.5% Ancamine 2914 (according to example 1), and as a comparative examples composition according to example 1 with the exception that composition comprised only Ancamine 2432.

Viscosity was measured according to following parameters: device: RHEOPLUS MCR102, measuring system: D-PP25; [d=1 mm] and shear rate:

d(gamma)/dt=0.1 1/s (constant shear rate).

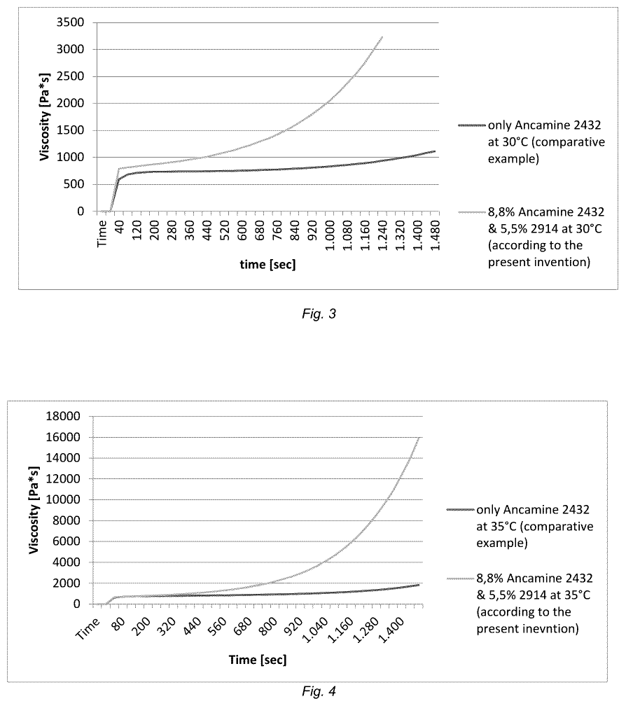

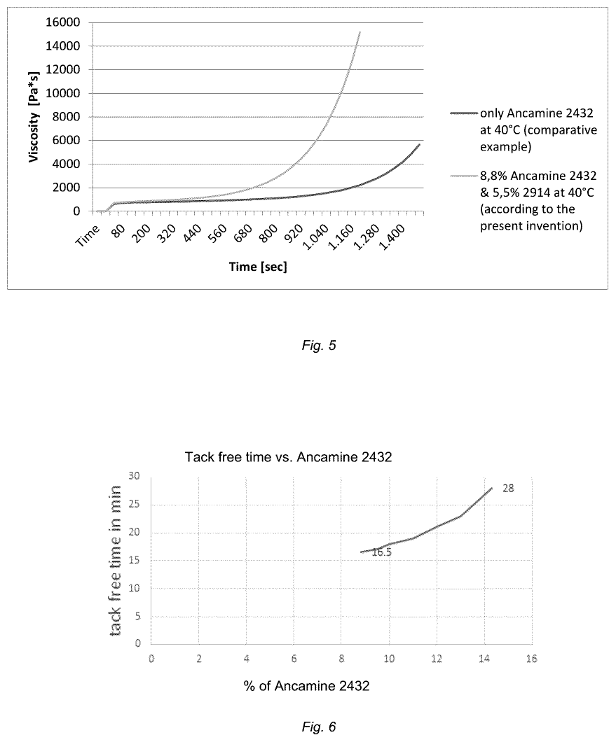

The results are illustrated in the FIGs. 3, 4 and 5. FIG. 3 illustrates the viscosity over time when measured at 30° C. FIG. 4 illustrates the viscosity over time when measured at 35° C. And FIG. 5 illustrates the viscosity over time when measured at 40° C.

### Example 6

Different amine levels' effect to the tack free time was investigated in example 6. Different first and second amine levels are listed in table 1 below for part B. Otherwise, the composition is based on the composition according to example 1.

TABLE 1

| | First amine | Second amine | |
|---|---|---|---|
| | (Ancamine 2432) | (Ancamine 2914) | Tack Free time |
| Example 1 | 27.5% | 16.5% | 16.5 |
| Example 6 | 29.6% | 14.4% | 17 |
| Example 7 | 31.1% | 12.9% | 18 |
| Example 8 | 34.1% | 9.9% | 19 |
| Example 9 | 37.1% | 6.9% | 21 |
| Example 10 | 40.1% | 3.9% | 23 |
| Comparative | 44% | | 28 |
| example 4 | | | |

Tack Free time of the examples were measured according to the method described below. This test method was used to determine the time required for materials to cure to a tack-free surface.

Tack free time test method:

Apparatus—glass plate, spatula—stainless steel, ˜101.6 mm (4 in.), and timing device, appropriate for measuring specified times. Perform all measurements at 23±2° C. (77±4° F.) and 50±5% RH.

Extrude a 50.8 mm (2 in.) sample of the test material approximately 6.4 mm (0.25 in.) wide onto a glass plate. Start the timer. At the specified time, bring the flat surface of a stainless-steel spatula lightly into contact with the sample. Record the time when the sample no longer exhibits adhesion or tack to the spatula as tack-free time.

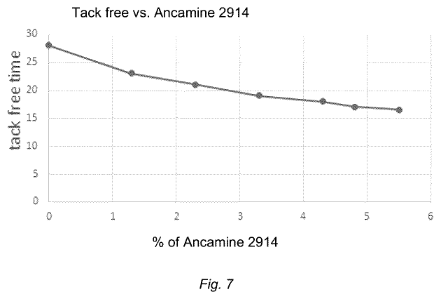

The results are illustrated in FIGS. 6 and 7.

1. A two-part, room temperature curable heat and fire retardant composition comprising
a first part comprising
1) an epoxy resin; and
2) a flame retardant compound;
and
a second part comprising
1) a first amine comprising N,N′-bis(3-aminopropyl)ethylenediamine and 3,3′-oxybis(ethylene-oxy) bis(propylamine);
2) a second amine comprising m-phenylenebis(methylamine) and formaldehyde, polymer with 1,3-benzenedimethanamine and phenol; and
3) a flame retardant compound.

2. A two-part, room temperature curable heat and fire retardant composition according to claim 1, wherein the epoxy resin is selected from the group consisting of epoxy resin based on bisphenol A and epichlorohydrin, bisphenol-A diglycidyl ether epoxy resin; bisphenol-F diglycidyl ether epoxy resin; cresol novolac epoxy resin, a C4-28 alkylene diglycidyl ether, a C2-28 alkylene- and/or alkenylene-diglycidyl ester; a C2-28 alkylene-, mono- and poly-phenol glycidyl ether; a polyglycidyl ether of trimethylol propane, pyrocatechol, resorcinol, hydroquinone, 4,4′,4″-trihydroxyphenyl methane, 4,4′-dihydroxydiphenyl methane, 4,4′-dihydroxy-3,3′-dimethyldiphenyl methane, 4,4′-dihydroxydiphenyl dimethyl methane, 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, or tris(4-hydroxyphyenyl)methane; a methylenebis(naphthalene)-diol, -triol, or -tetrol, 2,7,2′,7′-tetraglycidyloxynaphthalene methane and/or 1,1,2,2-tetrakis(4-glycidyloxyphenyl)ethane, cresol novolac epoxy resin sorbitol glycidyl ether, and mixtures thereof.

3. A two-part, room temperature curable heat and fire retardant composition according to claim 1, wherein the epoxy resin is present from 30 to 60% by weight of the total weight of the first part of the composition.

4. A two-part, room temperature curable heat and fire retardant composition according to claim 1, wherein the flame retardant compound in the first part and in the second part is same or different and is independently selected from the group consisting of, aluminium trihydroxide, mica, calcium carbonate, arsenic oxide, expanded graphite, calcium sulfate, cyanuric acid derivatives, cresyl diphenyl phosphate, triphenyl phosphate, tricresyl phosphate, tris-(isopropylated phenyl)-phosphate, trixylyl phosphate, tritoluyl phosphate, 2-ethylhexyl diphenyl phosphate, decyl diphenyl phosphate, tris-(2-chloroethyl)-phosphate, tris-(2-chloropropyl)-phosphate, tris-(2,3-dibromopropyl)-phosphate, tetrakis-(2-chloro)-ethylene diphosphate, dimethyl methyl phosphonate, diethyl ethyl phosphonate, chloroparaffins, hexabromobenzene, brominated diphenylethers, dibromoneopentyl glycol, mono pentaerythritol, dipentaerythritol, coated red phosphorus and mixtures thereof.

5. A two-part, room temperature curable heat and fire retardant composition according to claim 1, wherein the flame retardant compound is present in the first part from 35 to 65% by weight of the total weight of the first part of the composition.

6. A two-part, room temperature curable heat and fire retardant composition according to claim 1, wherein the flame retardant compound is present in the second part from 20 to 65% by weight of the total weight of the second part of the composition.

7. A two-part, room temperature curable heat and fire retardant composition according to claim 1, wherein the first amine and the second amine are present in the second part of the composition from 30 to 50% by weight of the total weight of the second part of the composition.

8. A two-part, room temperature curable heat and fire retardant composition according to claim 1, wherein the first amine and the second amine are present in a ratio of from 60:40 to 99:1.

9. A two-part, room temperature curable heat and fire retardant composition according to claim 1, wherein the composition further comprises a rheology modifier, wherein the rheology modifier may be present in the first part of the composition and/or the second part of the composition and is independently selected from the group consisting of fumed silica, fused silica, amorphous silica, hydrous silica, mineral nano silicate clay, and mixtures thereof.

10. A two-part, room temperature curable heat and fire retardant composition according to claim 9, wherein the rheology modifier is present in the first part of the composition from 0.1 to 5% by weight of the total weight of the first part.

11. A two-part, room temperature curable heat and fire retardant composition according to claim 1, wherein the composition further comprises a pigment, wherein the pigment may be present in the first part of the composition and/or the second part of the composition and is independently selected from the group consisting of titanium dioxide, carbon black, graphite, iron oxide and mixtures thereof.

12. A two-part, room temperature curable heat and fire retardant composition according to claim 11, wherein the pigment is present in the first part of the composition from 0.1 to 5% by weight of the total weight of the first part.

13. A two-part, room temperature curable heat and fire retardant composition according to claim 1, wherein the first part and the second part are mixed in a ratio of from 1.9:1.1 to 2.1:0.9.

14. A process to apply a two-part, room temperature curable heat and fire retardant composition according to claim 1 on a substrate comprising a step of applying the composition via a contactless coating.
